(19) United States
(12) Patent Application Publication
(10) Pub. No.: US 2012/0222907 A1
(43) Pub. Date: Sep. 6, 2012

(54) STRUCTURAL PART FOR A VEHICLE COMPRISING ELECTRIC ENERGY CELLS

(75) Inventors: Tim Schaefer, Niedersachswerfen (DE); Andreas Gutsch, Luedinghausen (DE)

(73) Assignee: Li-Tec Battery GmbH, Kamenz (DE)

(21) Appl. No.: 13/498,782

(22) PCT Filed: Sep. 22, 2010
(86) PCT No.: PCT/EP2010/005805

§ 371 Date: May 17, 2012

(30) Foreign Application Priority Data
Sep. 29, 2009 (DE) 10 2009 043 384.8

(51) Int. Cl. B60R 16/04; H01M 10/02; H01M 2/02

(52) U.S. Cl. 180/68.5; 429/162; 429/159; 429/127

(57) ABSTRACT

A structural part for a vehicle, e.g. a fender, floor, trunk lid, engine compartment cover, door, or roof of the vehicle, comprises a composite structure, in particular one that has a hollow cell structure such as a honeycomb structure or foam structure, said composite structure forming at least one cavity, each of which holds at least one or a plurality of electric energy cells, thus allowing batteries or the like to be accommodated in a vehicle in a compact manner and evenly distributed across the structure.

The present invention relates to a structural part comprising electric energy cells, an electric energy cell and a vehicle.

Vehicles with electric drive units, or at least electric supplementary drive units, are attracting increasing attention in anticipation of reducing supplies of fossil fuels and in the light of increasing adverse effects on the environment and climate. An criterion that is viewed as essential for the acceptance of electric vehicles is an appropriate and inconspicuous accommodation of the often voluminous storage batteries or accumulators (within this application, as is standard in automotive engineering, rechargeable electric accumulators are also designated as batteries).

### PRIOR ART

From WO 2009/021576 A1 it is known to implement a component of an energy supply system for a vehicle that is actively used for supplying power as a mounting part of the bodywork and/or to correspondingly incorporate such a component into the bodywork as an energy absorption element in the event of a force acting on the vehicle. Components considered as contributing to supplying energy in this context are, e.g., fuel cells or other components of a fuel cell system, or batteries, capacitors or the like. The component in this case functionally incorporated into the bodywork of the vehicle, e.g. as a cross member or door sill.

### DESCRIPTION OF THE INVENTION

It is an object of the present invention to improve the usage of electric energy storage units in vehicles.

The object is achieved by means of the features of the independent claims. Advantageous extensions of the invention form the subject matter of the dependent claims.

According to the invention, a structural part for a vehicle comprises a composite structure, in particular one that has a hollow cell structure such as a honeycomb structure or a foam structure, wherein said composite structure forms at least one cavity, each of which holds one or a plurality of electric energy cells.

According to the invention, in the structural part for a vehicle a plurality of electric energy cells is held, wherein the electric energy cells are electrically connected together in such a manner that from an electrical, electronic and control engineering point of view they form a self-contained unit.

According to the invention, a plurality of electric energy cells is held in the structural part for a vehicle, wherein a control device is provided which is designed and adapted to electrically isolate the electric energy cells of the structural part from an energy supply system of the vehicle individually, in groups or as a whole, when a predefined condition arises.

According to the invention, a plurality of flat, constructionally self-contained electric energy cells are accommodated in the structural part for a vehicle, wherein the electric energy cells comprise at least two current collectors, projecting sideways essentially perpendicular to the thickness direction of the structural part.

According to the invention, an electric energy cell is also provided which is designed and equipped to be installed in a structural part of the above described configuration.

According to the invention an electric energy module is additionally provided, which is constructed from a plurality of such electric energy cells, wherein the electric energy cells are installed in a structural part for a vehicle and electrically connected together in such a manner that from an electrical, electronic and control engineering point of view they form a self-contained unit.

According to the invention, a vehicle with at least one structural part of the above described configuration, or at least one electric energy module of the above described configuration, is also provided.

According to the invention an electric energy cell, in particular a secondary electric cell, is further provided which has an active part designed and equipped for supplying electric energy and having a flat shape, a preferably thin enclosure enclosing the active part in a sealed manner, and at least two current collectors which form electrical poles of the electric energy cell, wherein this electric energy cell is curved in at least one spatial direction.

According to the invention, an electric energy cell, in particular a secondary electric cell, is furthermore provided which has an active part designed and equipped for supplying electric energy and having a flat shape, a preferably thin enclosure which encloses the active part in a sealed manner, and at least two current collectors which form electrical poles of the electric energy cell, wherein this electric energy cell is pliable in at least one spatial direction.

A structural part in the context of the invention can be understood to mean any supporting or panelling part of a bodywork of the vehicle. It can therefore refer, for example, to a part of the chassis or the bodywork, or also a supporting bodywork part of a self-supporting bodywork for example. Particularly preferably, the structural part comprises a flat, in particular dish-shaped structure and forms in particular a fender, floor, trunk lid or engine compartment cover, door or roof of the vehicle. It is also conceivable however, that the structural part is a chassis, sill or the like, assuming that it can accommodate a plurality of electric energy cells.

An electric energy cell in the context of the invention can be understood as any device which is also designed and equipped for supplying electric energy. It can therefore in particular be a galvanic cell such as an electrochemical storage cell of the primary or secondary type (battery or accumulator cell), a fuel cell or a capacitor cell.

Particularly preferably, the electric energy cells are flat and constructionally self-contained and comprise at least two current collectors, projecting sideways essentially perpendicular to the thickness direction of the structural part. A constructionally self-contained electric energy cell is understood in the context of the invention as a self-contained module such as a galvanic cell that also comprises an active part, inside which charging, discharging and possibly conversion processes of electric energy take place. The active part can comprise stacks or film layers made of electrochemically active materials, conducting materials and insulating materials. It is understood in the context of the invention that taken as a whole, the cell comprises all features in order to be able to operate as an electric energy store, and the active part of the cell is enclosed by an enclosure or covering, preferably in a gas-tight and liquid-tight manner, wherein the covering preferably comprises a foil, where appropriate with a stabilizing frame or another type of wall structure. In this arrangement, so-called current collectors project from the interior of the active part, where they are conductively connected to electrode regions, through the covering to the outside of the cell and facilitate a connection of the active parts of the cells to one another or to a consumer. In the context of the invention, flat is to be understood as a body which has a substantially smaller extent in one spatial direction (defined in general as the thickness direction) than in the other two spatial directions. In addition to disc-shaped bodies, this definition also includes in particular, but not only, dish-shaped, saddle-shaped or otherwise curved bodies.

Particularly preferably, the electric energy cells are matched in thickness to the thickness of the structural part, so that the thickness properties of the structural part can be optimally exploited. They can also be curved in themselves and thus follow the geometry of the structural part.

To absorb any gases arising, the electric energy cells can comprise an expandable, multi-layered foil as their outer covering.

Since the electric energy cells are at least partially supported by the structural part, they can also be flexible in parts or be pliable, in order to be even better able to adapt to the geometry of the structural part.

According to the invention it is possible in particular, but not only, to accommodate batteries or the like in a vehicle in a compact manner and evenly distributed across the structure.

Particularly preferably, or according to a further aspect of the invention, the electric energy cells are electrically connected together in such a manner that from an electrical, electronic and control engineering point of view they form a self-contained unit. They can form a(n) (electric energy) module which is designed and adapted for supplying a uniquely assigned consumer, preferably an electric motor, in particular a wheel hub motor of a wheel (with regard to the demand characteristics of the consumer). Such a module can also be electrically isolated from an energy supply system of the vehicle in the event of damage occurring, with the result that the energy supply can be maintained by the damaged module without interruption.

In a preferred embodiment of the invention an electric vehicle is provided which has an electric drive unit and a plurality of battery cells as electric energy stores for the electric drive unit. The electric drive unit can be a single electric motor, the driving moment of which is distributed over the drive wheels. The drive unit can also comprise a plurality of electric motors which are each assigned to one drive wheel, in particular in the form of wheel hub motors. The electric drive unit can be an exclusive drive unit or operate together with a combustion engine.

The battery cells are preferably secondary cells (i.e. actually accumulator cells, but which are also termed batteries in automotive engineering), in particular lithium-ion cells, lithium-polymer cells or the like.

The vehicle comprises structural parts in a light-weight design. Structural parts in the context of the invention are understood to be structural weight-bearing parts, non-weight-bearing panelling parts and self-supporting bodywork parts. Structural parts can be in particular doors, engine compartment and trunk lids, floor shell, roof, fender, internal walls, chassis parts, sills, etc. The light-weight design is realized in particular by a honeycomb structure or similar hollow cell structure, which lends stability to a three-dimensional structure defined by an outer skin.

The battery cells are at least partly, preferably completely, accommodated in cavities within the light-weight structure. Items which can serve as a cavity are e.g. a honeycomb cell or the like or, if the hollow cells are finer than the size of the battery cells, a specially provided and constructed recess in the hollow cell structure. By this means, considerable parts of the volume of the structural parts can be used for holding the batteries. These volumes in the vehicle, such as in the engine compartment, trunk or passenger compartment, become free for other purposes. In particular, the space to be provided for the batteries inside the vehicle or even on the roof or in a trailer, is minimized or even completely eliminated. The previously empty space, which is present in the structural parts anyway, is applied for a practical purpose. The weight of the batteries is advantageously distributed over the vehicle structure.

The battery cells are generally constructed from a number of film layers, namely so that film layers with are arranged in an appropriate sequence with electrically or electrochemically active electrode materials, separator materials and conductor materials. The film packet is enclosed by an enclosure such that it is gas- and liquid-tight. The enclosure is typically implemented using a welded foil, which is preferably multi-layered. At least two current collectors are connected to the conductor materials of one type of electrode in each case and protrude through the enclosure out of the interior of the cell to the outside, where they are available for contacting.

The battery cells are implemented as prismatic cells, such as frame flat cells, pouch cells or coffee-bag cells, or as plate cells with relatively large-area dimensions. The current collectors and the contacting devices within the structural part are arranged alongside or away from the side of the battery cells. These connection parts thus do not contribute any additional thickness, and the thickness of the structural part can be optimally exploited for accommodating electrically or electrochemically active parts of the battery cells. The cells are clamped in clamping or tensioning devices, wherein the clamping device can also be the contacting device, i.e. it also serves to provide the electrical contacting for the current collectors. The contacting device can also serve to stiffen the structural element as well as the battery cells themselves.

In size and shape, in particular surface extent and thickness or cross-section, the cells are matched to the available space within the respective structural part. In particular, the cells have a curved shape, either convex or concave.

The battery cells are wired together in a structural part such that they form a meaningful unit in electrical, electronic and control engineering terms. in particular such a unit comprises pre-determined electrical properties such as voltage and charge storage capacity. The structural part with its battery cells therefore forms an inherently meaningful and exchangeable module. Thus after an accident, for example, a damaged module can be exchanged without other modules being affected from an electrical point of view.

In an extension of the present embodiment the battery cells of a structural part that are connected together to form a unit are assigned to a particular consumer. For example, a right-hand front fender, a passenger door and a front trunk lid or engine compartment cover forms three battery modules that are assigned to a wheel hub motor of the right-hand front wheel. Similarly a left-hand front fender, a driver's door and a floor shell form three battery modules which are assigned to a wheel hub motor of the left-hand front wheel. In the same way, a right-hand rear fender, a right-hand front passenger door and a rear trunk lid or engine compartment cover form three battery modules which are assigned to a wheel hub motor of the right-hand rear wheel. In addition, a left-hand rear fender, a left-hand passenger door and a vehicle roof form three battery modules which are assigned to a wheel hub motor of the left-hand rear wheel. Finally, walls between trunks or engine compartments, chassis parts, shock absorbers and the like form battery modules which are assigned to other consumers such as lights, heating/cooling systems, controllers, steering servo, navigation, audio/video, etc . . . . It is thereby also possible to increase the operational safety in the event of failure or partial failure of such a module or the like.

In a preferred embodiment a central or local control unit is provided, equipped and programmed, in order to a switch off or bypass module when pre-defined conditions occur. A pre-defined condition can be e.g. external damage and/or an electrical malfunction. Thus e.g. after an accident, a damaged module can be removed from the electrical assembly without affecting the other modules. The other modules can, where appropriate, assume the functions of the failed module. In order to be able to decide whether the pre-defined conditions are present, appropriate sensors such as temperature sensors, voltage sensors, strain gauges etc., are preferably provided.

In a further preferred embodiment a central control unit is provided, equipped and programmed to perform a charge equalisation between battery modules as required and based on pre-defined or pre-definable criteria. Thus e.g. in darkness, in particular at night, on longer journeys when lights are used, in particular full beam headlamps and/or fog lamps, charge can be transferred from other battery modules to the battery modules assigned to the lighting when the charge state of the battery module assigned to the lighting falls below a pre-defined threshold. In the same way, e.g. on journeys in cold weather, charge can be transferred from other battery modules to the battery modules assigned to the heating, when the charge state of the battery module assigned to the heating falls below a pre-defined threshold. Similar criteria can be applied for other battery modules.

The voltage of a module is, or can be, limited. Preferably, the voltage of a module lies between 48V and 150V, in a lightweight electric vehicle between 7.2V and 36V. The voltage of a module is the sum of the voltages of the individual cells, which in the case of lithium systems can be e.g. 2.7V or 3.6V up to as much as 5V. Particularly preferably the voltage of a module is designed to suit the demand of the standard consumers, in particular a wheel hub motor.

In a preferred embodiment the battery cells are implemented as binary cells.

Binary cells is the term used to describe battery cells which comprise at least two electrode stacks in a common housing. The two electrode stacks are preferably implemented differently, in particular with different electrical properties. By means of binary cells, desired electrical properties can be realised in a particularly compact form. In particular, it is possible to obtain higher cell voltages than those obtained with single cells. In the case of binary cells, cell voltages of up to 12 V can be obtained.

In a further preferred embodiment, the battery cells are implemented in such a manner that they fit closely to the shape of the structural part. In particular, the battery cells are flexible and the enclosure is in contact with the structural part over a large area. The structural part thereby supports the battery cell and forms at least a partial contact for the cell.

In a further preferred embodiment the enclosure of the battery cells is formed from an elastic film. Changes in the volume of the cell, caused by gas releases in its interior, can therefore be absorbed. If, in addition, space is provided in the structural part for expansion, damage can be prevented. The operating safety can thereby be further increased. The flexibility of the film used can be provided in sections. The flexibility of the film can also be achieved with a particularly thin film. Since the cells are supported by the structural part, the film can be thinner than is found in conventional coffee-bag cells or the like. A degassing space is formed, but one which cannot lead to a cascade effect on the other cells, which also applies in particular when binary cells are used. In the event of a crash the composite material will also prevent spark formation, or material or hot gas escaping uncontrollably from a destroyed battery, since it is captured in a type of air-bag or the like.

In a preferred embodiment the cell components, which are preferably laminated into the structural elements, use the structural element as a heat-sink.

Although in the foregoing the present invention has been described in its essential features by reference to concrete preferred exemplary embodiments and extensions, it is also understood that the invention is not restricted to these exemplary embodiments, but can be modified and extended within the scope and range defined by the claims, for example, but not exclusively, as indicated hereafter.

The bodywork parts can also be produced in a conventional manner, instead of in a light-weight design. E.g. a bodywork part can comprise an outer metal sheet, an inner cladding and a number of stiffening members, perhaps in the form of ribs or stringers. In such a case, battery cells can be accommodated and mounted in the gaps between the stiffening members.

Battery cells can also be used, the current collectors or poles of which are arranged on one or both of the flat sides of the cell. In such a case, the current collectors are contacted by means of flat cables or tape contacting. In this way, the increased thickness can be limited by the contacting means.

According to the above description the battery cells are clamped into the structural parts in holders. This clamping is assumed to be releasable, so that the cells can be removed again. In an alternative the cells are embedded in the structural parts in an unreleasable manner, in particular they are laminated in. The contacting means can in this case also be laminated in. Such a design allows the level of integration to be increased, among other things, which can also simplify the maintenance.

It is understood that all indicated extensions and variations of the above embodiment can be combined with one another, except where this is technically impossible.

The present invention is applicable to all types of vehicles, thus in particular, but not only, to powered vehicles, motorcycles, water-borne vehicles, aircraft or the like.

The above considerations are moreover not limited only to electrically powered vehicles, but can also be applied anywhere where electric energy storage units requiring a certain amount of space are found, and where structural elements that can be configured as described above are available. Examples of these are electrical generation, distribution and supply equipment, in which e.g. storage and back-up batteries can be accommodated in suitably designed walls, floors, ceilings, platforms and the like.

In addition to batteries or rechargeable batteries, capacitors, Supercaps, fuel cells and the like are conceivable for use as electric energy cells.

The batteries could also be inserted as modules, distributed over holding devices which are under a lid, for example to provide a good rear centre of gravity, or assigned to the wheels in a uniform distribution. Here it could be conceivable that the batteries are essentially freely relocatable according to the load requirements of the vehicle design, but wherein one or two back-up packs are always available in case of defects or as a reserve. As an approximation to the objective of free relocatability, a bodywork can be provided with a plurality of holding devices for batteries and/or with externally accessible, coverable compartments. These holding devices and/or compartments are preferably populated with batteries according to the desired position of the centre of gravity of the vehicle.

Solar films or solar modules on top of, on or in the vehicle can independently supply power, which is used for ventilating the battery modules, even when the vehicle is outdoors in sunlight, or for pre-heating in cold weather. In driving conditions, a coolant or airflow can be optionally be used in addition.

In some vehicle models a conceivable option is insertion to the right and left in combination with or behind the rear lights, since in some circumstances space would be available here along the fender or inclined at an angle or downwards into the trunk, as far as the area where the exhaust muffler or exhaust system would previously have been. In electric vehicles with an additional combustion engine to extend the range (e.g. for the so-called E-Cell-Plus design with Range Extender by Mercedes) this would also be possible in the front in the region of the headlamps, wherein here the module is mostly inserted upwards or straight.

Also, battery cells can be built into or inserted into the C-pillar.

It is also possible that one or more modules in a high-power version are installed, in order to operate the Range Extender for example, or to enhance booster effects (short-term high accelerations); optionally this can also be used for energy recuperation.

Low-voltage on-board network applications can be operated and supplied by means of the high-voltage battery assembly. I.e., part of the modules or sub-assemblies is operated at a lower voltage level than the main battery assembly. For this purpose, a small number of cells can be connected in series and form a sub-battery, in order to provide an on-board voltage of, for example, but not necessarily, approximately 14V. Multiple such series connections connected in parallel can be operated with a constant 14 V, for example. Such a sub-battery could be for example purely electrically sub-divided into two groups: 2 to 4 cells, possibly also bipolar cells, for on-board voltage, and a large number, for example 10 to 35 cells or bipolar cells for “high-voltage” for supplying the drive motors.

Thus from 2 or 4, alternatively 10-35 modules an on-board network level with 14V or a high-voltage level with for example 300 V can be reproduced, which allows any on-board alternator present to be very efficiently designed, and in turn contributes to the overall efficiency of the vehicle. The on-board alternator could, in the absence of a combustion engine, or similarly a bicycle dynamo, provide the on-board voltage supply. With the sub-division of a sub-battery according to the above explanation the on-board alternator could be dimensioned smaller or even be completely eliminated.

It is also possible to incorporate additional voltage levels or to combine power and energy modules, for example to balance out load cases of the vehicle.

By means of solar-powered fans, a battery module in the dislodged bay can be ventilated with air. For the event that water intrudes into the bay, which is open at the top, the structure is designed such that it bypasses the protected battery contacts.

In a further variation it can be provided that sub-batteries can be exchanged from outside, possibly in a mechanically supported manner. To achieve this, a sub-battery can be accommodated by a coverable compartment, accessible from outside. A wall of this sub-battery could simulteneously form the lid of this compartment. Such a solution can also be characterized in that the cell or module battery is aerodynamically optimized and arranged in order to also present a low flow resistance. For this purpose the shape of the lid can be adapted to suit the adjoining part of the bodywork or exterior skin to prevent air vortices. The lid could also comprise cooling fins.

This form of the rechargeable battery ensures a rapid exchange or extraction by hand or by means of mechanisms/robots, if the energy management system and the BMS have enabled this via the release mode, so that no problem can occur due to high voltage or arcs. BMS can disable the removal device, for example for safety reasons, when the battery is too hot.

The modules/cells can furthermore be implemented in such a manner that when removed they are not provided with a high voltage.

A cell or a module can be electronically secured and monitored, for example via an RFID which stores module events and transmits them to the battery management system (BMS) in advance. Thus, after the module is opened or manipulated the BMS can establish this in the security check.

As with printer cartridges, constructional means can be used to ensure that only suitable batteries can be inserted the correct way round. In a replacement test mode, the BMS can therefore test new or replacement modules for suitability prior to insertion and enable them for operation in the vehicle or via the energy management system for example perform state-of-health monitoring and display the results to the operator. A balancing or equalising charge can be performed, so that batteries are combined together in the vehicle battery assembly as homogeneously as possible.

This communication to the BMS of the battery module to be exchanged before insertion can take place by means of RFID or similar, so that only properly identified battery assembly modules are accepted or rejected by the system. In order to prevent tampering, the insertion is optionally disabled either electrically or mechanically or in a similar manner.

Ventilation can also take place in the sandwich floor (double vehicle floor) by means of openings into which the fan is mounted and air is blown in from below or from one side, preferably from the front. Only in emergencies is energy from the rechargeable battery used for this purpose, for example when danger is present.

If an accident occurs, the battery can be caught in a heat-resistant cover, foam enclosure or battery air-bag in which gases are trapped or which does not transfer heat. The module can thus be recovered without risk, and no contamination can occur.

In a vehicle the rechargeable battery can be stacked in a shelf arrangement or be arranged in a standing/lying position, so that anyone opening the lid/hood or a shoe-cupboard-like arrangement or a rotating shelf (restrained mechanically, electromechanically or by other means) can easily access the modules.

1-25. (canceled)

26. A structural part for a vehicle, comprising:
a composite structure that forms at least one cavity, each of which holds one or a plurality of electric energy cells; and
a control device configured to:
detect structural conditions of the structural part, and
electrically isolate the electric energy cells of the composite structure from an energy supply system of the vehicle individually, in groups or as a whole, when a predefined condition arises, wherein the predefined condition is a predefined structural condition of the structural part.

27. The structural part according to claim 26, wherein the control device is further configured to:
detect operating states of the electric energy cell,
electrically isolate the electric energy cells of the structural part from the energy supply system of the vehicle individually, in groups or as a whole, when a predefined condition arises, wherein the predefined condition is a predefined operating condition of an electric energy cell or a group of electric energy cells.

28. The structural part according to claim 26, wherein the electric energy cells are at least one of partially flexible, pliable or spatially curved.

29. The structural part according to claim 26, wherein the electric energy cells are flat and constructionally self-contained and include at least two current collectors that project sideways in a direction substantially perpendicular to a thickness direction of the structural part.

30. A structural part for a vehicle, wherein the structural part holds a plurality of flat, constructionally self-contained electric energy cells, the electric energy cells include at least two current collectors that project sideways in a direction substantially perpendicular to a thickness direction of the structural part.

31. The structural part according to claim 29, wherein the electric energy cells are clamped in clamping devices.

32. The structural part according to claim 26, wherein the structural part includes a flat or dish-shaped structure.

33. The structural part according to claim 32, wherein the electric energy cells are laminated into a structure of the structural part.

34. The structural part according to claim 26, wherein the electric energy cells have a prismatic, plate-shaped or flat framework structure.

35. The structural part according to claim 26, wherein the electric energy cells are matched in thickness to a thickness of the structural part.

36. The structural part according to claim 26, wherein a control device to control the electric energy cells is held in the structural part.

37. The structural part according to claim 26, wherein the electric energy cells include an expandable, multi-layered foil as their outer covering.

38. An electric energy cell which is designed and equipped for installation in a structural part according to claim 26.

39. An electric energy cell including an active part that supplies electric energy and having a flat shape and at least two current collectors which form electrical poles of the electric energy cell, wherein the electric energy cell is pliable.

40. The electric energy module which is assembled from a plurality of electric energy cells according to claim 39, wherein the electric energy cells are installed in a structural part for a vehicle and are electrically connected together to from a closed unit from an electrical, electronic and control engineering point of view.

41. The electric energy module according to claim 40, wherein the electric energy module is configured as a traction battery or as part of a traction battery to supply at least one electric motor serving as a drive unit of the vehicle.

42. The electric energy module according to claim 40, wherein the electric energy module is assigned to a consumer and is designed with regard to demand characteristics of the consumer.

43. A vehicle having at least one structural part according to claim 26.

44. An electric energy cell including an active part to supply electric energy and being formed in a flat shape and at least two current collectors which form electrical poles of the electric energy cell, wherein the electric energy cell is curved in at least one spatial direction.

45. The structural part for a vehicle according to claim 26, wherein the composite structure includes a hollow cell structure, a honeycomb structure or a foam structure.

46. The structural part for a vehicle according to claim 32, wherein the structural part includes a fender, a floor plate or a floor shell, a trunk lid or an engine compartment cover, a door or a roof of the vehicle.

47. The electric energy cell according to claim 39, wherein the electric energy cell is an electric secondary cell.

48. The electric energy cell according to claim 39, wherein the electric energy cell includes a thin enclosure which encloses the active part in a sealed manner.

49. The electric energy cell according to claim 44, wherein the electric energy cell is an electric secondary cell.

50. The electric energy cell according to claim 44, wherein the electric energy cell includes a thin enclosure which encloses the active part in a sealed manner.

51. A vehicle having at least at least one electric energy module according to claim 40.
